(19) United States
(12) Patent Application Publication
(10) Pub. No.: US 2005/0265462 A1
(43) Pub. Date: Dec. 1, 2005

(54) METHOD AND APPARATUS FOR DYNAMICALLY MANAGING POWER CONSUMPTIONS OF SENDING AND RECEIVING DRIVERS

(75) Inventors: Serafino Bueti, Waterbury, VT (US); Kai Di Feng, Essex Junction, VT (US); Suzanne Granato, Essex Junction, VT (US); Allen Prescott Haar, State College, PA (US); Anthony J. Perri, Jericho, VT (US); Hemen Rajendra Shah, South Burlington, VT (US)

Correspondence Address: DILLON & YUDELL LLP, 8911 NORTH CAPITAL OF TEXAS HWY, SUITE 2110, AUSTIN, TX, 78759, US

(73) Assignee: INTERNATIONAL BUSINESS MACHINES CORPORATION, Armonk, NY (US)

(21) Appl. No.: 10/709,808

(22) Filed: May 28, 2004

(51) Int. Cl. H04L 25/00; H04B 3/00; H04L 7/00

(52) U.S. Cl. 375/257

(57) ABSTRACT

A method for managing power consumptions of a sending driver and a receiving driver within a data communication system is disclosed. The sending driver is coupled to a sender and a sensor. The receiving driver is coupled to a receiver and a controller. The sensor adjusts a transmission frequency and a supply voltage level to the sending driver according to the amount of data that needed to be sent by the sender. Data within the sender are then transmitted by the sending driver to the receiving driver according to the adjusted transmission frequency and the adjusted supply voltage level.

### BACKGROUND OF INVENTION

1. Technical Field

The present invention relates to data communications in general, and, in particular, to a method and apparatus for providing data communications between components. Still more particularly, the present invention relates to a method and apparatus for managing power consumptions of sending and receiving drivers utilized in data communication systems.

2. Description of Related Art

Referring now to the drawings and in particular to FIG. 1, there is illustrated a block diagram of an apparatus for providing data communications between two components, according to the prior art. As shown, a sender 11 is coupled to a receiver 12 via a sending driver 13 and a receiving driver 14. Sending driver 13 is capable of sending data provided by sender 11 to receiving driver 14 through a transmission line 15. After data have been received, receiving driver 14 is capable of passing the received data to receiver 12. Sender 11 can be a write buffer circuit, an integrated circuit device, an adaptor card, a computer system, etc. Similarly, receiver 12 can be a receiver buffer circuit, an integrated circuit device, an adaptor card, a computer system, etc. Transmission line 15 can be a trace on a circuit board, a discrete wire or a controlled impedance cable such as a coaxial cable.

When there are data needed to be sent by sender 11, the data will be passed to sending driver 13. The data are then sent out to receiving driver 14 via transmission line 15. When there are no data needed to be sent by sender 11, sender 11 may issue a control signal to let sending driver 13 to power down in order to save power. Hence, sending driver 13 is only capable of either operating at full power or idling at low power. The present disclosure provides an improved method for managing the power consumption of sending driver 13 and receiving driver 14.

### SUMMARY OF INVENTION

In accordance with a preferred embodiment of the present invention, a data communication system includes a sender coupled to a sending driver and a receiver coupled to a receiving driver. Both the sender and the sending driver are coupled to a sensor. In addition, the receiving driver and the receiver are coupled to a controller. The sensor adjusts a transmission frequency and a supply voltage level to the sending driver according to the amount of data that needed to be sent by the sender. Data within the sender are then transmitted by the sending driver to the receiving driver according to the adjusted transmission frequency and the adjusted supply voltage level.

All features and advantages of the present invention will become apparent in the following detailed written description.

### BRIEF DESCRIPTION OF DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of an apparatus for providing data communications between two components, according to the prior art;

FIG. 2 is a block diagram of an apparatus for providing data communications between two components, in accordance with a preferred embodiment of the present invention;

FIG. 3 is a block diagram of a power control circuit for the sending driver and the sender in FIG. 2, in accordance with a preferred embodiment of the present invention; and

FIG. 4 is a block diagram of a power control circuit for the receiving driver and the receiver in FIG. 2, in accordance with a preferred embodiment of the present invention.

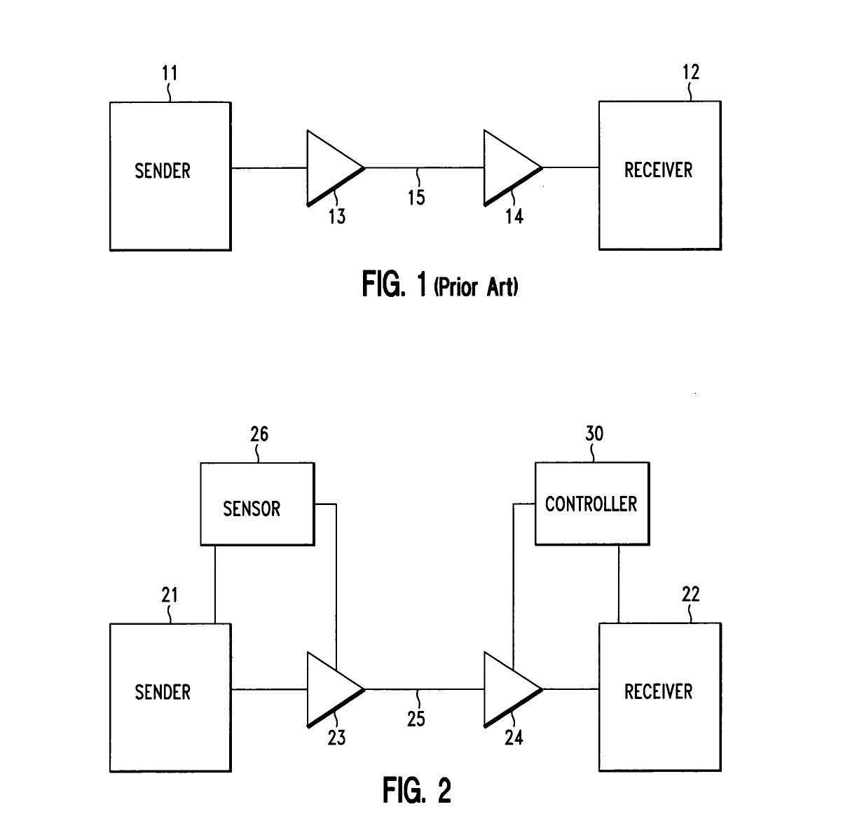

### DETAILED DESCRIPTION

In general, the transmission power P in a data communication system with a high-impedance receiver can be expressed as
P˜C*V²
where C=capacitance of a transmission line
V=transmission voltage change on the transmission line

Thus, the lowering of the logic-high voltage on a transmission line within a data communication system even a little can yield significant power reductions.

With reference now to FIG. 2, there is depicted a block diagram of an apparatus for providing data communications between two components within a data communication system, in accordance with a preferred embodiment of the present invention. As shown, a sender 21 is coupled to a receiver 22 via a sending driver 23 and a receiving driver 24. Sending driver 23 is capable of sending data to receiving driver 24 via a transmission line 25. Sender 21 can be a write buffer circuit, an integrated circuit device, an adaptor card, a computer system, etc. Similarly, receiver 22 can be a receive buffer circuit, an integrated circuit device, an adaptor card, a computer system, etc.

Sending driver 23 is an adaptive driver that is capable of operating at a lower voltage when running at a lower clock rate. Similarly, receiving driver 24 is also an adaptive driver that is capable of operating at a lower voltage when running at a lower clock rate.

A sensor 26 is coupled to sender 21 and sending driver 23. Sensor 26 detects the level of data that needed to be sent by sender 21. As an example of the present embodiment, there are three levels of data threshold in sender 21, namely, high, medium and low.

When the level of data within sender 21 is high, which means sender 21 has a large amount of data that needed to be sent, sensor 26 provides sending driver 23 with a maximum power supply input (e.g., 1.8 V), and allows sending driver 23 to run at the highest clock frequency (e.g., 100 Mhz). At the above-mentioned settings, sending driver 23 operates at a maximum operating condition and consumes the most power.

When the level of data within sender 21 is medium, which means sender 21 has a moderate amount of data that needed to be sent, sensor 26 provides sending driver 23 with a medium power supply input (e.g., 1.3 V), and allows sending driver 23 to run at a medium clock frequency (e.g., 50 MHz). At the above-mentioned settings, sending driver 23 operates at a medium operating condition and consumes the medium power.

When the level of data within sender 21 is low, which means sender 21 has a small amount of data that needed to be sent, sensor 26 provides sending driver 23 with the lowest power supply input (e.g., 1.1 V), and allows sending driver 23 to run at the lowest clock frequency (e.g., 25 MHz). At the above-mentioned settings, sending driver 23 operates at a minimum operating condition and consumes the minimum power.

When there is no data in sender 21 that needed to be sent, sensor 26 provides sending driver 23 with the same low power supply input, and allows sending driver 23 to idle in order to save power.

Sensor 26 performs the above-mentioned power control by passing messages or using sideband signals via specific control signals. The sideband signals include clock frequency controls such as run at full clock frequency run at ½ clock frequency, run at ¼ clock frequency, etc. Sideband signals also include power supply controls such as operate at 1.8 V, operate at 1.3 V, operate at 1.1 V, etc. in conjunction with the respective clock frequency controls.

A controller 30 is coupled to receiving driver 24 and receiver 22. Controller 30 detects the voltage level on transmission line 25. Because sending driver 23 may receive one of the three different voltage levels from sensor 26, sending driver 23 is capable of sending data at the same three different voltage levels. Controller 30 receives a message or sideband signals from sensor 26 and adjusts the supply voltage as well as the clock frequency to receiving driver 24 and receiver 22, accordingly.

Examples of transmission of messages and sideband signals are described in the following two paragraphs. The transmission of messages or sideband signals between sensor 26 and controller 30 can be performed either in parallel or in serial. For parallel transmissions, three groups of transmission lines are required, namely, a clock line, data lines and speed indicator lines. On the transmit side, sender 21 includes a first-in first-out (FIFO) buffer to store data for transmission. Within the FIFO buffer, a write pointer is compared to a read pointer to determine the quantity of data with respect to the various thresholds such as ¾ full, ½ full, ¼ full and empty. The transmit clock is sent out to controller 30. Two output lines are coded to indicate which speed with which the data should be transmitted according to the quantity of data. The data are transmitted at the new speed on the cycle following the change in the encoding of the speed indicators. As the data is being placed into the FIFO buffer (from empty), the speed indicator is encoded based on the quantity of data. As the quantity passes a threshold, the speed indicator changes its value accordingly. Controller 30 samples the speed indicator lines and the data lines using the transmit clock. Based on the value of the speed indicators, controller 30 detects a change in the data lines after the indicated number of cycles. When there is no data needed to be transmitted, a data value of 0 is transmitted.

For serial transmissions, only a single data line and a clock line are required. On the transmit side, a FIFO is used to store the data for transmission. Within the FIFO buffer, a write pointer is compared to a read pointer to determine quantity of data with respect to the various thresholds such as ¾ full, ½ full, ¼ full and empty. The transmit clock is sent out to controller 30. The encoding of the data lines is such that there are data characters and special characters (non-data characters). An 8b10b encoding is one example. A special character is used to represent the start of data, and another special character is used to represent the end of data (i.e., empty FIFO buffer). Unique special characters are used to determine the speed at which the data are transmitted. Beginning with the clock cycle following the special character, the data are transmitted at the indicated rate. As data is placed into the FIFO buffer (from empty), the start character indicates the start of transmission, and the special character for the speed is then transmitted followed by the data. As the quantity of data passes a threshold, a respective special character for indicating a speed change is sent. When the FIFO buffer is emptied, the end character is sent. Controller 30 samples the serial line using the transmit clock. Based on the value of the speed characters, controller 30 detects the serial line after the indicated number of cycles. When there is no data needed to be transmitted, a logical 0 value is transmitted on the serial line.

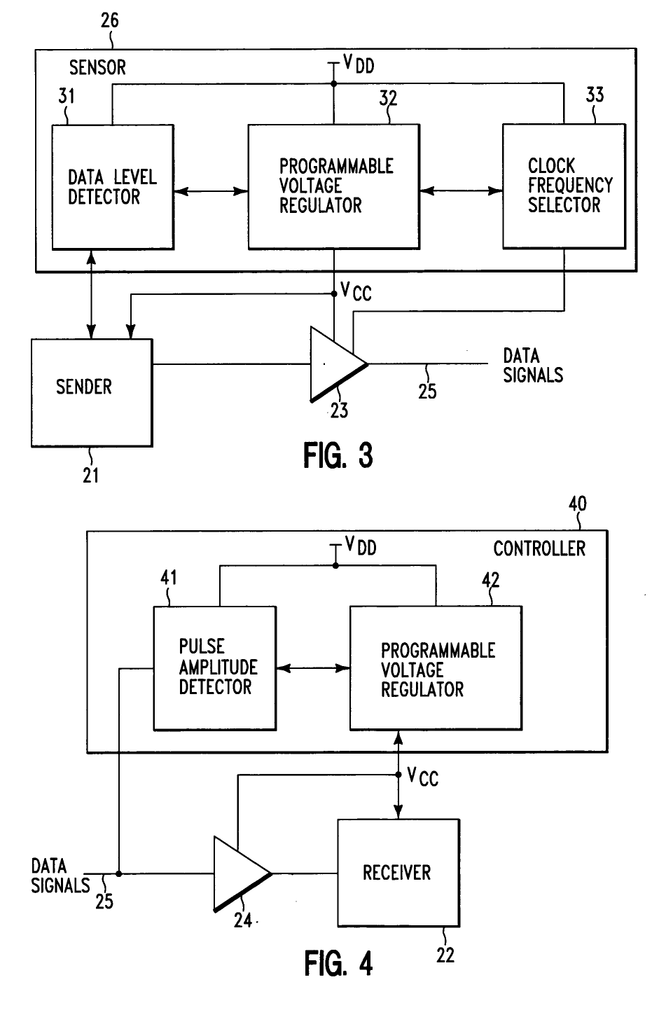

Referring now to FIG. 3, there is depicted a detail block diagram of sensor 26, in accordance with a preferred embodiment of the present invention. As shown, sensor 26 includes a data level detector 31 and a programmable voltage regulator 32. During operation, data level detector 31 detects the data level within sender 21. When the data level falls below a first predetermined threshold (i.e., data level within sender 21 drops from high to medium), data level detector 31 sends a signal to programmable voltage regulator 32 to lower the V_{CC} supply voltage to sending driver 23. For example, programmable voltage regulator 32 can lower the V_{CC} supply voltage to sending driver 23 from 1.8 V to 1.3 V. Data level detector 31 also sends a signal to clock frequency selector 33 to lower the transmission frequency by sending driver 23 on transmission line 25. For example, clock frequency selector 33 can lower the transmission frequency by sending driver 23 on transmission line 25 by one half of the normal transmission frequency.

When the data level falls below a second predetermined threshold (i.e., data level within sender 21 drops from medium to low), data level detector 31 sends a signal to programmable voltage regulator 32 to even lower the V_{CC} supply voltage to sending driver 23. For example, programmable voltage regulator 32 can lower the V_{CC} supply voltage to sending driver 23 from 1.3 V to 1.1 V. Data level detector 31 also sends a signal to clock frequency selector 33 to even lower the transmission frequency by sending driver 23 on transmission line 25. For example, clock frequency selector 33 can lower the transmission frequency by sending driver 23 on transmission line 25 by one quarter of the normal transmission frequency.

When the data level falls below a third predetermined threshold (i.e., data level within sender 21 drops from low to zero), data level detector 31 sends a signal to programmable voltage regulator 32 to maintain the V_{CC} supply voltage to sending driver 23 at a low level, such as 1.1 V. Data level detector 31 also sends a signal to clock frequency selector 33 to idle sending driver 23.

With reference now to FIG. 4, there is depicted a detail block diagram of controller 40, in accordance with a preferred embodiment of the present invention. As shown, controller 40 includes a pulse amplitude detector 41 and a programmable voltage regulator 42. During operation, pulse amplitude detector 41 detects the voltage level of input signals on transmission line 25. When the voltage level on transmission line 25 drops to, for example, 1.3 V, pulse amplitude detector 41 sends a signal to programmable voltage regulator 32 to lower the V_{CC} supply voltage to receiving driver 24 and receiver 22 accordingly. Similarly, when the voltage level on transmission line 25 drops to, for example, 1.1 V, pulse amplitude detector 41 sends a signal to programmable voltage regulator 42 to lower the V_{CC} supply voltage to receiving driver 24 and receiver 22 accordingly.

As has been described, the present invention provides an improved method and apparatus for managing power consumptions of sending and receiving drivers.

While the invention has been particularly shown and described with reference to a preferred embodiment, it will be understood by those skilled in the art that various changes in form and detail may be made therein without departing from the spirit and scope of the invention.

1. A method for managing power consumptions of a sending driver and a receiving driver, wherein said sending driver sends data received from a sender to said receiving driver via a transmission line, said method comprising:
coupling a sensor to said sender and said sending driver;
in response to an amount of data that needed to be sent by said sender, adjusting a supply voltage level by said sensor to said sending driver accordingly; and
transmitting data from said sender by said sending driver on said transmission line to said receiving driver according to said adjusted supply voltage level.

2. The method of claim 1, wherein said method further includes adjusting a transmission frequency by said sensor to said sending driver according to said amount of data needed to be sent by said sender.

3. The method of claim 2, wherein said method further includes transmitting data from said sender by said sending driver on said transmission line to said receiving driver according to said adjusted transmission frequency.

4. The method of claim 1, wherein said sensor includes a data level detector.

5. The method of claim 1, wherein said sensor includes a programmable voltage regulator.

6. The method of claim 1, wherein said sensor includes a clock frequency selector.

7. The method of claim 1, wherein said method further includes coupling a controller to said receiving driver.

8. The method of claim 7, wherein said method further includes adjusting a supply voltage level by said controller to said receiving driver according to the voltage level of data on said transmission line.

9. The method of claim 7, wherein said controller includes a pulse amplitude detector.

10. The method of claim 7, wherein said controller includes a programmable voltage regulator.

11. An apparatus for managing power consumptions of a sending driver and a receiving driver, wherein said sending driver sends data received from a sender to said receiving driver via a transmission line, said apparatus comprising:
a sensor coupled to said sender and said sending driver;
means for adjusting a supply voltage level to said sending driver according to an amount of data that needed to be sent by said sender detected by said sensor; and
means for transmitting data from said sender by said sending driver on said transmission line to said receiving driver according to said adjusted supply voltage level.

12. The apparatus of claim 11, wherein said sensor further includes means for adjusting a transmission frequency of said sending driver according to said amount of data needed to be sent by said sender.

13. The apparatus of claim 12, wherein said sending driver further includes means for transmitting data on said transmission line to said receiving driver according to said adjusted transmission frequency.

14. The apparatus of claim 11, wherein said sensor includes a data level detector.

15. The apparatus of claim 11, wherein said sensor includes a programmable voltage regulator.

16. The apparatus of claim 11, wherein said sensor includes a clock frequency selector.

17. The apparatus of claim 11, wherein said apparatus further includes a controller coupled to said receiving driver.

18. The apparatus of claim 17, wherein said controller further includes means for adjusting a supply voltage level to said receiving driver according to a voltage level of data on said transmission line.

19. The apparatus of claim 17, wherein said controller includes a pulse amplitude detector.

20. The apparatus of claim 17, wherein said controller includes a programmable voltage regulator.
